(19) United States
(12) Patent Application Publication
(10) Pub. No.: US 2025/0307742 A1
(43) Pub. Date: Oct. 2, 2025

(54) WORK SUPPORT SYSTEM, WORK SUPPORT METHOD, AND INFORMATION STORAGE MEDIUM

(71) Applicant: Cybozu, Inc., Tokyo (JP)

(72) Inventors: Yuki NAKAJIMA, Tokyo (JP); Wataru IIJIMA, Kitamoto-shi (JP); Kazutoshi NAKANO, Saitama-shi (JP); Taishi SATO, Tokyo (JP); Masaki TAKAHASHI, Setouchi-shi (JP); Shogo NINOMIYA, Ichikawa-shi (JP)

(21) Appl. No.: 19/091,778

(22) Filed: Mar. 26, 2025

(30) Foreign Application Priority Data
Mar. 29, 2024 (JP) 2024-055512

(51) Int. Cl. G06Q 10/0631

(52) U.S. Cl. CPC G06Q 10/06316

(57) ABSTRACT

A work support system configured to support work of a user includes at least one processor configured to: acquire registration data registered in the work support system; acquire, based on input of the user, user input information relating to an electronic document to be generated; execute generation-related processing relating to generation of the electronic document, based on the registration data, the user input information, and an AI; and provide the electronic document to the user.

### CROSS-REFERENCE TO RELATED APPLICATION

The present disclosure contains subject matter related to that disclosed in Japanese Patent Application JP2024-055512 filed in the Japan Patent Office on Mar. 29, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, in a work support system capable of supporting work of users, a user may create an electronic document such as an invoice or a report. For example, in Japanese Patent Application Laid-open No. 2023-172386, there is described a viewing-purpose portable-document-format (PDF) data generation system which extracts, from PDF data, other embedded PDF data embedded in the PDF data and data for rendering, stores those pieces of data on a cloud server, creates a link based on the PDF data, the embedded PDF data, and the data for rendering, and generates PDF data for viewing on the cloud server.

However, in the technology of Japanese Patent Application Laid-open No. 2023-172386, the user himself or herself is required to provide PDF data from which PDF data for viewing is generated, thereby requiring the user to take time and labor. This point also applies to electronic documents other than the PDF data among electronic documents created in the work support system. The related art requires a user to take time and labor to create an electronic document in the work support system, and thus has not been able to sufficiently increase convenience of the user.

### SUMMARY OF THE INVENTION

One object of the present disclosure is to increase convenience of a user.

According to at least one aspect of the present disclosure, there is provided a work support system, which is configured to support work of a user, the work support system including at least one processor configured to: acquire registration data registered in the work support system; acquire, based on input of the user, user input information relating to an electronic document to be generated; execute generation-related processing relating to generation of the electronic document, based on the registration data, the user input information, and an AI; and provide the electronic document to the user.

### BRIEF DESCRIPTION OF THE DRAWINGS

FIG. 1 is a diagram for illustrating an example of a hardware configuration of a work support system.

FIG. 2 is a view for illustrating an example of a work support screen displayed on a user terminal.

FIG. 3 is a view for illustrating an example of the work support screen displayed on the user terminal.

FIG. 4 is a diagram for illustrating an example of functions implemented in the work support system.

FIG. 5 is a diagram for illustrating an example of an AI used in generation of an electronic document.

FIG. 6 is a table for showing an example of a work support database.

FIG. 7 is a flow chart for illustrating an example of processing executed in the work support system.

FIG. 8 is a diagram for illustrating an example of functions implemented in a work support system according to modification examples.

FIG. 9 is a view for illustrating an example of how a user corrects the electronic document.

FIG. 10 is a diagram for illustrating an example of processing for correction of the electronic document.

### DESCRIPTION OF THE EMBODIMENTS

### 1. Hardware Configuration

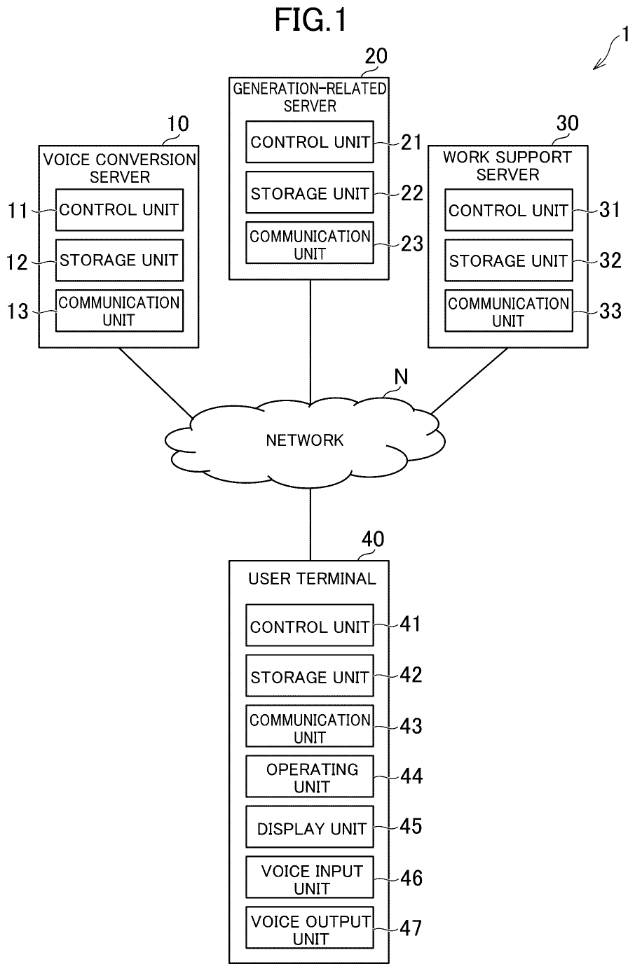

An example of a work support system, a work support method, and a program according to at least one embodiment of the present disclosure is described. FIG. 1 is a diagram for illustrating an example of a hardware configuration of the work support system. For example, a work support system 1 includes a voice conversion server 10, a generation-related server 20, a work support server 30, and a user terminal 40. Each of the voice conversion server 10, the generation-related server 20, the work support server 30, and the user terminal 40 is connected to a network N such as the Internet or a LAN. One voice conversion server 10, one generation-related server 20, one work support server 30, and one user terminal 40 are illustrated in FIG. 1, but at least one thereof may be provided as two or more components.

The voice conversion server 10 is a server computer that executes voice conversion processing described below. For example, the voice conversion server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The generation-related server 20 is a server computer that executes generation-related processing described below. For example, the generation-related server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The work support server 30 is a server computer that executes work support processing described below. For example, the work support server 30 includes a control unit 31, a storage unit 32, and a communication unit 33. Hardware configurations of the control unit 31, the storage e unit 32, and the communication unit 33 may be the same as those of the control unit 11, the storage unit 12, and the communication unit 13, respectively.

The user terminal 40 is a computer of a user. For example, the user terminal 40 is a personal computer, a tablet terminal, a smartphone, or a wearable terminal. The user terminal 40 includes a control unit 41, a storage unit 42, a communication unit 43, an operating unit 44, a display unit 45, a voice input unit 46, and a voice output unit 47. Hardware configurations of the control unit 41, the storage unit 42, and the communication unit 43 may be the same as those of the control unit 11, the storage unit 12, and the communication unit 13, respectively. The operating unit 44 includes an input device such as a mouse or a touch panel. The display unit 45 includes a liquid crystal display or an organic EL display. The voice input unit 46 includes at least one microphone. The voice output unit 47 includes at least one speaker.

Programs stored in the storage units 12, 22, 32, and 42 may be supplied via the network N. A hardware configuration of each of the voice conversion server 10, the generation-related server 20, the work support server 30, and the user terminal 40 is not limited to the example of FIG. 1. For example, at least one of the voice conversion server 10, the generation-related server 20, the work support server 30, or the user terminal 40 may include at least one of a reading unit (for example, a memory card slot) that reads a computer-readable information storage medium or an input/output unit (for example, a USB terminal) for directly connecting to an external device. A program stored in the information storage medium may be supplied to at least one of the voice conversion server 10, the generation-related server 20, the work support server 30, or the user terminal 40 through at least one of the reading unit or the input/output unit.

Moreover, the work support system 1 is only required to include at least one computer. The computers included in the work support system 1 are not limited to the example of FIG. 1. For example, the work support system 1 may include only the generation-related server 20 and the work support server 30. In this case, the voice conversion server 10 and the user terminal 40 are present outside the work support system 1. The work support system 1 may include only the generation-related server 20. In this case, the voice conversion server 10, the work support server 30, and the user terminal 40 are present outside the work support system 1. The work support system 1 may include the generation-related server 20 and another server computer.

### 2. Overview of Work Support System

In the at least one embodiment, the work support system 1 can support work of users. Further, in the at least one embodiment, a case in which the work support system 1 can support work of users with no-code or low-code is taken as an example, but the work support system 1 can support work of users based on code input by the user. That is, the work support system 1 may be a system that is not classified as a system capable of supporting work of users with no-code or low-code.

The no-code means that the user does not input any code. In other words, the no-code means that the user is not required to input any code to use the work support system 1. The low-code means that the user inputs only minimum required code. In other words, the user is only required to input the minimum required code to use the work support system 1.

The code refers to a command for a computer. In other words, the code refers to information for a computer to understand an instruction of the user. The code may be any code used in the field of computer software. For example, the code may be a programming language code, a cascading style sheets (CSS) code, a database language code, a markup language code, or another code. Programming languages also include languages called scripting languages. The code in the at least one embodiment may be any one of various codes that a person skilled in the field of computer software calls code.

The work support system 1 being able to support work of users with no-code means that the work support system 1 can execute work support processing described below based on code provided in advance even when the user does not input any code. The work support system 1 being able to support work of users with low-code means that, as long as the user inputs only the minimum required code, the work support system 1 can execute the work support processing described below based on the minimum required code input by the user and the code provided in advance.

The meaning of each of the terms “no-code” and “low-code” may be a commonly known meaning. A person skilled in the field of computer software can understand the meaning of each of the no-code and the low-code based on the common general technical knowledge at the time of filing. Each of the no-code and the low-code may have a publicly-known meaning that a person skilled in the art can understand based on the common general technical knowledge at the time of filing. For example, an amount of the minimum required code for the low-code may be an amount that a person skilled in the art can understand based on the common general technical knowledge at the time of filing. For example, the amount of the minimum required code for the low-code may be about 1 line to 100 lines, or may be 101 lines or more.

For example, the work support system 1 has various work support functions for supporting work of users. The work support function is a function implemented by a program developed for work support. Types of work support functions may be publicly-known types. For example, the work support function may be a database function for the user to store data in a database, a communication function for the user to communicate with another user, a schedule function for the user to manage a schedule, an email management function for the user to manage emails, or another function.

In the at least one embodiment, a case in which the work support system 1 provides users with groupware of a cloud type is taken as an example. The work support system 1 may provide users with groupware of an on-premises type. The work support system 1 may provide users with a service that is not classified as groupware but supports work. For example, an organization such as a corporation to which users belong contracts with the work support system 1. As a member of the organization, each user uses the work support function of the work support system 1. When the user logs in to the work support system 1 from a browser of the user terminal 40, the user terminal 40 displays, on the display unit 45, a work support screen for the user to use the work support function. The work support screen may be displayed on a program dedicated to the work support system 1 instead of being displayed on a browser.

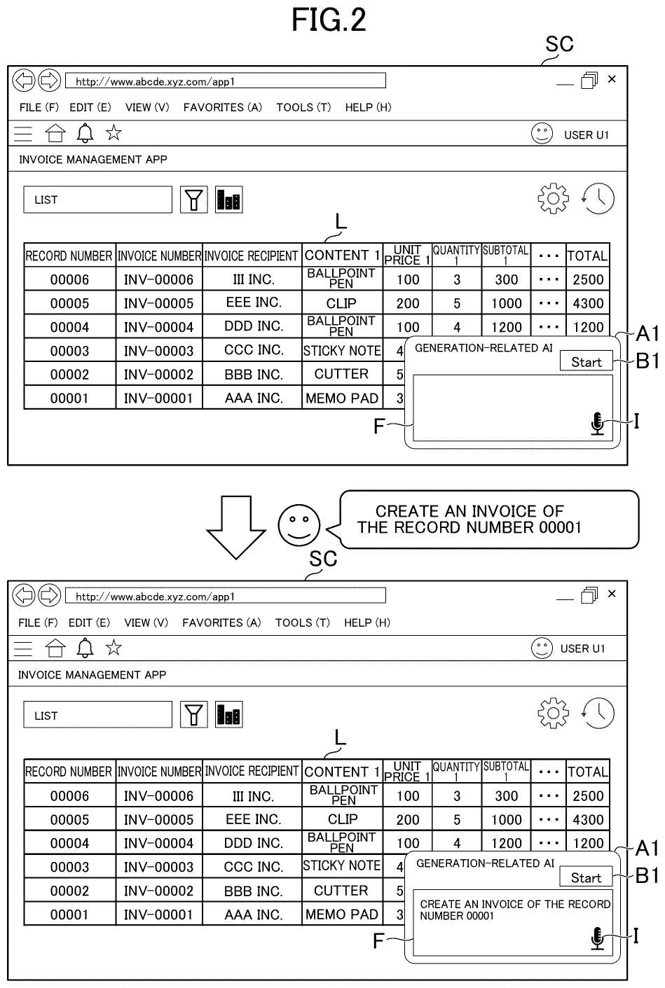

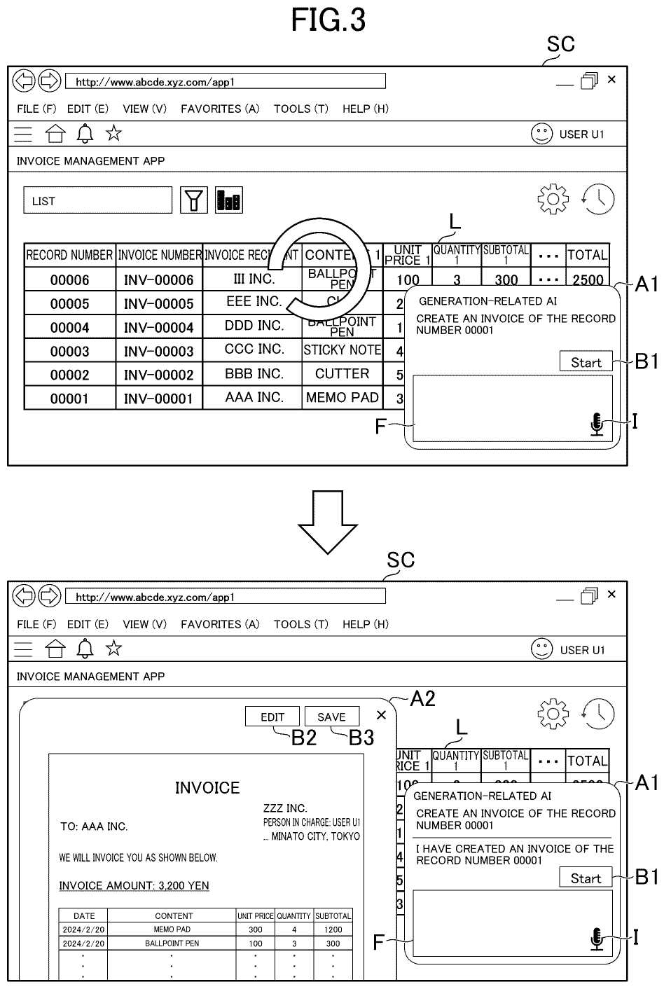

FIG. 2 and FIG. 3 are diagrams for illustrating examples of the work support screen displayed on the user terminal 40. In the at least one embodiment, a case in which the user uses a database function is taken as an example. For example, the user uses an app that is a type of database. The user can store, in the app, any data relating to his or her own work. For example, the user can store, in the app, not only data stored in fields of the app but also other data. For example, the user can store, in the app, comments on other users, files such as documents or images, or other data. The app can be said to be a complex work support function that combines not only the database function but also a communication function and a file management function.

For example, when the user selects the app, the user terminal 40 displays, on the display unit 45, a work support screen SC indicating a list L of records that are units of data that forms the app as in the upper half of FIG. 2. In the example in the upper half of FIG. 2, records of an invoice management app for the user to manage an invoice are shown in the list L. When the user selects a record in the list L, the user terminal 40 displays details of the record on the work support screen SC. For example, the user can update the record from the work support screen SC.

In the at least one embodiment, the user can create an app with no-code or low-code. For example, the user can create an app by performing only a simple setting task such as a field setting even without inputting any code. The user can use a default app provided in advance even without performing a setting task. The user can extend the work support function of the app by inputting the minimum required code. That is, the user can create a low-code app by extending the work support function of the app created with no-code. The extension of the work support function can also be said to be customization of the work support function.

For example, each record displayed in the list L stores information required for creating an invoice. The invoice is an example of an electronic document. Thus, the invoice as described herein can be read as the electronic document. The user creates an invoice based on the information stored in the record. The invoice may have any format. For example, the invoice may have a document file format such as PDF, a file format that can be read by spreadsheet software, an image file format, a markup language file format such as HTML or XML, or another format.

For example, it is conceivable that the user inputs code for creating an invoice from the information stored in the record to create a program as an extension function of the app. In this case, the work support server 30 or the user terminal 40 can execute the program created by the user and generate an invoice. However, it is difficult for a user with no knowledge of programming languages or a little knowledge of programming languages to create a program. Even when the user has knowledge of programming languages, much time and labor are required to create a program.

In view of this, the work support system 1 according to the at least one embodiment has an electronic document generation function of generating an electronic document exemplified by an invoice through use of an artificial intelligence (AI). The electronic document generation function is a type of work support function. The electronic document generation function may be a default function (function that can be used by all users from the beginning) of the work support system 1, but in the at least one embodiment, is assumed to be a plug-in that can be freely added by the user. The user who wishes to use the electronic document generation function adds the electronic document generation function by the plug-in. The plug-in is a collection of programs and data for the electronic document generation function. When the user adds the plug-in, the user can use the programs and data for the electronic document generation function.

The AI is a program having artificial intelligence that supports work of users. There are various views in terms of definitions of the AI, but the AI in the at least one embodiment may be an AI defined by any one of various publicly-known definitions. The AI may be an AI called a generative AI or a conversational AI. Examples of the AI may include a large language model, a machine learning model not classified as a large language model, a program called a bot, or other programs. There are also various views in terms of definitions of machine learning, but the machine learning in the at least one embodiment may be machine learning defined by any one of various publicly-known definitions. The machine learning may be any one of supervised learning, semi-supervised learning, or unsupervised learning.

In the at least one embodiment, a case in which the large language model corresponds to the AI is taken as an example. For example, the user uses text (characters) or voice to give an instruction to the AI. In the example in the upper half of FIG. 2, the user selects an icon I for starting voice input, and speaks. When the voice input unit 46 detects the voice of the user, the user terminal 40 executes, between the user terminal 40 and the voice conversion server 10, processing for converting the voice of the user into text. When the voice of the user is converted into text, as in the lower half of FIG. 2, the user terminal 40 displays the text in an input form F. When the text is incorrect, the user can correct the text by operating the operating unit 44. The user can also manually input text in the input form F without using the voice input.

In the example in the lower half of FIG. 2, the user gives an instruction such as “Create an invoice of the record number 00001.” The record number is a number used for identifying each individual record. For example, record numbers are automatically assigned in an order of record creation. When the user selects a button B1, the generation-related server 20 uses the AI to generate an invoice corresponding to the record designated by the user. As the upper half of FIG. 3, the work support screen SC is in a state waiting for the generation of an electronic document. The instruction input by the user is displayed in a display region A1 of the work support screen SC.

For example, when the AI generates an invoice, the generation-related server 20 transmits, to the work support server 30, an API request indicating that the invoice generated by the AI is to be deployed to the app. The AI may generate an API request. The work support server 30 receives the API request from the generation-related server 20. The work support server 30 deploys the invoice to the app based on the API request. This enables the user terminal 40 to display the invoice in an environment of the work support system 1. As in the lower half of FIG. 3, the user terminal 40 displays the invoice generated by the AI in a display region A2 of the work support screen SC.

For example, when the user selects a button B2, the work support screen SC shifts to an edit mode for the invoice. The user can edit the invoice from the work support screen SC in the edit mode. The invoice may be edited by a publicly-known editor. The editor may be operable on a browser. The editor may operate as an extension function of the browser. For example, when the invoice has a document format such as PDF, the user terminal 40 edits the invoice based on a publicly-known document editor. When the invoice has another format such as an image format, it suffices that the user terminal 40 edits the invoice by a publicly-known editor capable of editing a file in another format. When the user selects a button B3, the invoice is saved in the app.

As described above, when the user inputs an instruction to the AI, the generation-related server 20 generates an invoice that meets the instruction. The generation-related server 20 transmits, to the work support server 30, the API request indicating that the invoice generated by the AI is to be deployed. The work support server 30 executes the processing requested by the API request and deploys the invoice. This enables the user to easily create an invoice even without creating an invoice by himself or herself or inputting code, and hence the work support system 1 can increase convenience of the user. Details of the work support system 1 are described below.

### 3. Functions Implemented in Work Support System

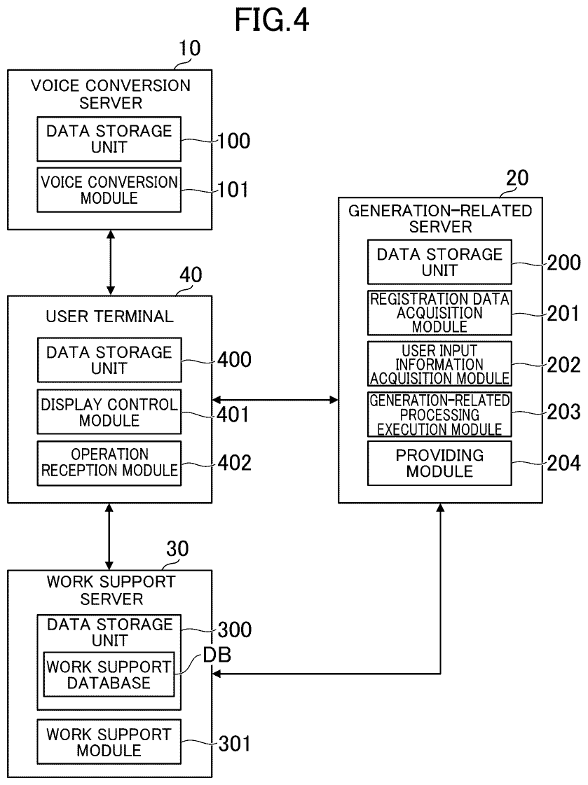

FIG. 4 is a diagram for illustrating an example of functions implemented in the work support system 1.

### 3-1. Functions Implemented in Voice Conversion Server

For example, the voice conversion server 10 includes a data storage unit 100 and a voice conversion module 101. The data storage unit 100 is implemented by the storage unit 12. The voice conversion module 101 is implemented by the control unit 11. When voice input is not performed, the work support system 1 is not required to include the voice conversion server 10.

### Data Storage Unit

The data storage unit 100 stores data required for the voice conversion processing. For example, the data storage unit 100 stores a voice conversion program indicating the voice conversion processing. The voice conversion processing is at least one of processing for converting voice into text or processing for converting text into voice. In the at least one embodiment, a case in which the voice conversion processing includes both of those kinds of processing is taken as an example, but the voice conversion processing may be only any one of those kinds of processing. The voice conversion program for converting voice into text and the voice conversion program for converting text into voice may be separately provided. The voice conversion program may be a publicly-known program. For example, the voice conversion program may be a program of a pattern matching method using a voice waveform pattern, a machine learning method, or another method.

### Voice Conversion Module

The voice conversion module 101 executes the voice conversion processing based on the voice conversion program. For example, the voice conversion server 10 acquires input voice data indicating voice input by the user from the user terminal 40. A data format of the input voice data may be a publicly-known format. The voice conversion module 101 converts the voice input by the user into text based on the voice data and the voice conversion program. The voice conversion module 101 transmits input text data indicating text of the voice input by the user to the user terminal 40. The voice conversion module 101 may transmit the input text data to the generation-related server 20, the work support server 30, or another computer.

For example, the voice conversion module 101 acquires answer text data indicating text of an answer from the AI from the generation-related server 20, the work support server 30, or another computer. The voice conversion module 101 converts the text of the answer from the AI into voice based on the answer text data and the voice conversion program. The voice conversion module 101 transmits answer voice data indicating voice of the text of the answer from the AI to the user terminal 40. The user terminal 40 acquires the answer voice data from the voice conversion server 10. The user terminal 40 outputs the answer from the AI by voice from the voice output unit 47 based on the answer voice data. The user terminal 40 may acquire the answer text data from the voice conversion server 10, the generation-related server 20, the work support server 30, or another computer. The user terminal 40 may display the answer from the AI in the display region A1 of the work support screen SC based on the answer text data.

### 3-2. Functions Implemented in Generation-Related Server

For example, the generation-related server 20 includes a data storage unit 200, a registration data acquisition module 201, a user input information acquisition module 202, a generation-related processing execution module 203, and a providing module 204. The data storage unit 200 is implemented by the storage unit 22. Each of the registration data acquisition module 201, the user input information acquisition module 202, the generation-related processing execution module 203, and the providing module 204 is implemented by the control unit 21.

### Data Storage Unit

The data storage unit 200 stores data required for generation-related processing. For example, the data storage unit 200 may store information (for example, a URL or an IP address) that can identify an API endpoint of the API in the work support server 30. In the at least one embodiment, a case in which the generation-related server 20 uses the AI of an external service that cooperates with the work support system 1 is taken as an example, and hence it is assumed that the data storage unit 200 does not store the AI itself, but the data storage unit 200 may store the AI itself. That is, in the at least one embodiment, a case in which actual data of the AI is stored in a system for another service is taken as an example, but the data storage unit 200 may store the actual data of the AI.

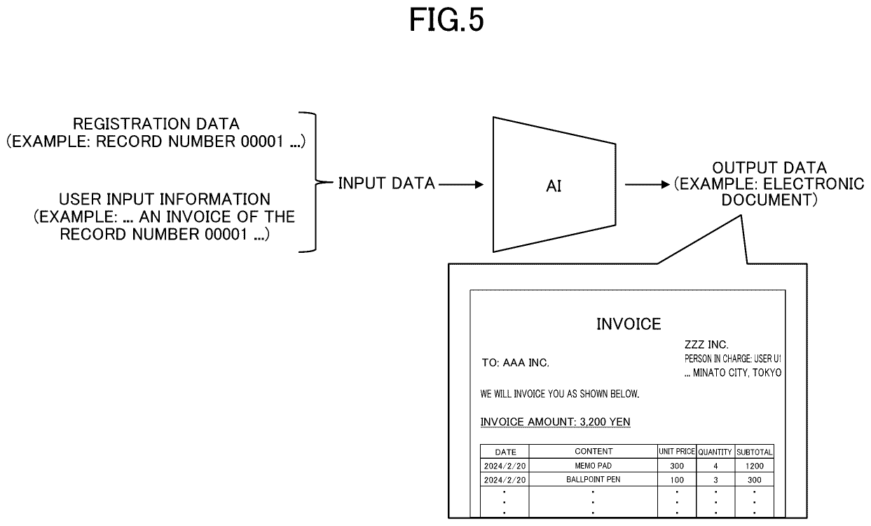

FIG. 5 is a diagram for illustrating an example of the AI used in generation of an electronic document. For example, the AI includes: a program indicating a series of processing steps such as calculation of an embedded representation; and parameters to be referred to by the program. The embedded representation is information for the AI to understand the meaning of data. For example, the embedded representation is represented by a multidimensional vector. The embedded representation may also be called a feature amount indicating a feature of data. The embedded representation may be represented in another format other than the multidimensional vector. The AI may include other data (for example, data equivalent to a dictionary of terms) other than the parameters. The other data is referred to by the program. The other data may be data separate from the AI. The AI calculates the embedded representation of input data input to itself based on the parameters, and performs output corresponding to the embedded representation. For example, the parameters are weights and biases.

The program and parameters of the AI may be a publicly-known program and publicly-known parameters, respectively. For example, the program and parameters of the AI may be a program and parameters employed in a large language model, such as a generative pre-trained transformer (GPT) or bidirectional encoder representations from transformers (BERT), a program and parameters employed in a machine learning model, such as a neural network or generative adversarial networks (GAN), a program and parameters employed in a generative AI or a conversational AI that is not classified into those, or another program and other parameters. The program and parameters of the AI may be selected from various programs and parameters that can be understood by a person skilled in the field of computer software based on the common general technical knowledge at the time of filing.

In the at least one embodiment, a large language model (for example, GPT) is described as an example of the AI, and hence the program of the AI indicates processing for analyzing input data input to the AI. The parameters of the AI are parameters such as weights and biases that are referred to by the AI to analyze the meaning in a natural language. The AI performs language analysis on the input data input to itself based on the parameters adjusted by training, and performs output corresponding to a result of the language analysis. For example, the AI divides the text in a natural language indicated by the input data into a plurality of tokens. The AI calculates the embedded representations indicating the meanings of the individual tokens based on the parameters. The AI understands the meaning in a natural language based on a sequential order of the embedded representations of the respective tokens. The AI may make a prediction based on the sequential order of the embedded representations of the respective tokens as required. The AI outputs output data corresponding to the sequential order of the embedded representations.

In the at least one embodiment, a case in which various codes related to data generation (such as database language codes) have been learned by the AI is taken as an example. The AI may learn only an electronic document that can be handled by the work support system 1, but in the at least one embodiment, it is assumed that other electronic documents have been learned as well. The AI may be capable of handling various electronic documents. The AI may also have learned a large number of other natural languages (for example, programming languages) in addition to the electronic documents. For example, the output data from the AI may differ depending on the input data. When the input data is some question, the output data indicates an answer to the question. When the input data is an instruction to generate an electronic document, the output data includes the electronic document. In this case, the output data may include not only the electronic document but also an explanation of the electronic document. The output data may include any type of information.

As in FIG. 5, in the at least one embodiment, a case in which the input data to the AI includes registration data and user input information, which are described later, is taken as an example. The input data can include any information. The input data is not limited to the example in the at least one embodiment. In the at least one embodiment, a case in which the output data includes the electronic document is taken as example. For example, the output data may include information (for example, an answer from the AI) other than the electronic document. The output data from the AI may not include the electronic document but may include code to be used to generate an electronic document. The output data is not required to include the electronic document. For example, when the output data does not include the electronic document, the generation-related processing execution module 203 described later may generate an API request for requesting generation of the electronic document based on the output data. For example, when the output data is code such as a script generated by the AI and includes only code for generating an electronic document, the generation-related processing execution module 203 may generate an API request for the execution of the code based on the output data that is the code such as a script generated by the AI. The API request is transmitted to another computer such as the work support server 30, and the other computer generates an electronic document based on the API request.

### Registration Data Acquisition Module

The registration data acquisition module 201 acquires registration data registered in the work support system 1 capable of supporting work of users. The registration data is data to be referred to for generation of an electronic document. For example, all or part of content of the registration data is included in the electronic document. All or part of the content of the registration data may be processed in some way before being included in the electronic document, instead of being included in the electronic document as it is. The registration data registered in the work support system 1 refers to data stored by the work support system 1. The registration data may be any data that can be used by the user.

In the at least one embodiment, a case in which the record of the app corresponds to the registration data is taken as an example. Thus, the record as described herein can be read as the registration data. Further, a case in which each individual record corresponds to the registration data is taken as an example, but a plurality of records may correspond to one piece of registration data. The registration data may be all the records or some of the records. For example, the registration data may be only a part of the record that indicates a specific value of a field. The registration data may include not only the specific value of the field but also another part such as a file or a comment registered in the record.

In the at least one embodiment, a case in which the registration data is stored in a work support database DB described later is taken as an example. Thus, the registration data acquisition module 201 acquires the registration data from the work support database DB. For example, the registration data acquisition module 201 acquires a piece of registration data designated by the user from among a large number of pieces of registration data stored in the work support database DB. In the examples of FIG. 2 and FIG. 3, the user input information includes acquisition target identification information for identifying the pieces of registration data to be acquired by the registration data acquisition module 201. The acquisition target identification information may be any information such as the record number. The registration data acquisition module 201 acquires the piece of registration data identified by the acquisition target identification information.

The method by which the registration data acquisition module 201 identifies the registration data to be acquired is not limited to the above-mentioned example. That is, instead of identifying the registration data designated by the user as the registration data to be acquired, the registration data acquisition module 201 may identify, by another method, the registration data to be acquired. For example, when the user selects a specific record from the list L, details of the record selected by the user are displayed on the work support screen SC. When the user instructs the generation of an electronic document under that state, the registration data acquisition module 201 may identify the record currently displayed on the work support screen SC as the registration data to be acquired. It is assumed that the registration data acquisition module 201 acquires the acquisition target identification information, such as the record number of the record currently displayed on the work support screen SC, from the user terminal 40.

Further, when the registration data is data other than the record of the app, the registration data acquisition module 201 is only required to acquire the registration data registered as the other data. For example, the registration data acquisition module 201 may acquire a record of another database other than the app as the registration data. The registration data acquisition module 201 may acquire the registration data of another work support function other than the database function exemplified by the app. For example, the registration data acquisition module 201 may acquire, as the registration data, posted data relating to a post of the user input in the communication function, schedule data relating to a schedule managed in the schedule function, email data relating to an email managed in the email management function, or other data.

Further, when the registration data is stored in another database other than the work support database DB, the registration data acquisition module 201 may acquire the registration data from the other database. When the registration data is stored in the data storage unit 200, the registration data acquisition module 201 may acquire the registration data from the data storage unit 200. When the registration data is stored in another computer other than the generation-related server 20 and the work support server 30, or an external information storage medium, the registration data acquisition module 201 may acquire the registration data from the other computer or the external information storage medium.

### User Input Information Acquisition Module

The user input information acquisition module 202 acquires user input information relating to the electronic document to be generated, based on input of the user. In the at least one embodiment, a case in which the user inputs voice from the voice input unit 46 is taken as an example, but the user may also perform the input from the operating unit 44. For example, the user may input an instruction to the AI from the operating unit 44. The user may perform the input by selecting a part (for example, an image such as a button or a check box) serving as a user interface.

The user input information is an instruction to the AI. The user input information can also be said to be an intention of the user. The user input information may also be called a prompt for the AI. Among the pieces of information included in the input data, other pieces of information other than the user input information can also be said to be supplementary information to be input to the AI together with the prompt.

There are various definitions of the term “prompt,” but when the information to be input to the AI corresponds to a prompt, other pieces of information other than the user input information also correspond to prompts. The definition of the term “prompt” may be any one of various publicly-known definitions. In the at least one embodiment, the user input information is written in a natural language, but may be information in which the meaning in a natural language is vectorized.

For example, the user inputs a natural language indicating a type of electronic document to be generated. In the examples of FIG. 2 and FIG. 3, the user inputs the type of electronic document as “invoice” in a natural language. The AI may be capable of handling a plurality of types of electronic documents. For example, the AI may be capable of handling estimates, receipts, reports, proposals, meeting minutes, company regulations, contracts, forms that are not classified as any of those, or other types of electronic documents. The user inputs a natural language indicating at least one of the plurality of types of electronic documents.

The user may input in another manner other than in a natural language. For example, a list of types of electronic documents that can be handled by the AI may be displayed on the work support screen SC, and the user may select the type of electronic document from the list. The user input information indicates the type of electronic document selected by the user. The work support screen SC may display buttons indicating individual types of electronic documents in place of the list. The user may designate the type of electronic document to be generated by selecting the button.

In the at least one embodiment, a case in which the text input in the input form F when the user selects the button B1 corresponds to the user input information is taken as an example. Thus, the user input information is text indicating the content relating to the electronic document that the user wishes to generate. When the user selects the button B1, the user terminal 40 transmits the user input information, which is the text input in the input form F, to the generation-related server 20. The user input information acquisition module 202 acquires the user input information from the user terminal 40. The user input information acquisition module 202 may acquire only one piece of user input information, or may acquire a plurality of pieces of user input information.

The user input information may not be text in a natural language but may be the voice itself that has been used in the input by the user. In this case, the user input information acquisition module 202 may acquire the user input information, which is the voice, from the user terminal 40 and then request the voice conversion server 10 to convert the user input information into text. The user input information acquisition module 202 acquires the user input information converted into text from the voice conversion server 10. In the at least one embodiment, the AI is a large language model, and hence the information converted into text is input to the AI. The user input information acquisition module 202 may acquire the user input information indirectly through the voice conversion server 10, the work support server 30, or another computer, instead of acquiring the user input information directly from the user terminal 40.

### Generation-related Processing Execution Module

The generation-related processing execution module 203 executes the generation-related processing. The generation-related processing is processing relating to the generation of an electronic document. In the at least one embodiment, a case in which the processing for generating an electronic document itself corresponds to the generation-related processing is taken as an example, but the generation-related processing may be pre-processing that is executed in advance for generating the electronic document. For example, the pre-processing may be generation of a file (for example, a comma-separated values (CSV) file) to be imported as the electronic document, generation of a program for generating the electronic document, generation of an API request for requesting the generation of the electronic document, or other processing.

In the at least one embodiment, the generation-related processing execution module 203 executes the generation-related processing relating to the generation of the electronic document based on the registration data and the user input information. For example, the generation-related processing execution module 203 inputs the input data including the registration data and the user input information to the AI. In the at least one embodiment, the AI is stored in an external system, and hence the generation-related processing execution module 203 transmits the input data to the external system. When the AI is stored in the data storage unit 200, the generation-related processing execution module 203 is only required to input the input data to the AI stored in the data storage unit 200.

For example, the AI calculates the embedded representation of the input data based on parameters adjusted by previously performed training. In the at least one embodiment, a case in which a large language model exemplified by GPT corresponds to the AI is taken as an example, and hence the AI divides the input data into tokens and calculates the embedded representations of the individual tokens based on the parameters. The AI predicts a continuation based on the sequential order of the embedded representations of the tokens as required. The AI outputs the electronic document as the output data based on the sequential order. The AI may output the output data including not only the electronic document but also the text of the answer to the user. The generation-related processing execution module 203 acquires the electronic document included in the output data output by the AI. In the at least one embodiment, the above-mentioned series of processing steps corresponds to the generation-related processing.

For example, the registration data indicates content included in the electronic document. In the examples of FIG. 2 and FIG. 3, values of the fields of each record stored in the app correspond to the content included in the electronic document exemplified by the invoice. The AI has previously learned a large amount of training data including electronic documents for training, and thus can understand such registration data by language analysis and select content that is required to be included in the electronic document as required. In addition, the user input information is acquired based on the input of the user, and hence the content of an electronic document for which the user wishes is indicated in the user input information. In the examples of FIG. 2 and FIG. 3, the user input information indicates specific content such that the user wishes for an invoice of the record number 00001. The AI can understand such user input information by language analysis and generate an electronic document for which the user wishes.

The AI generating an electronic document based on the registration data of the work support system 1 is a novel configuration at the time of filing, but a technology publicly known at the time of filing may be used as a technology itself for the AI to generate an electronic document based on a prompt. Thus, a person skilled in the art can understand the processing in which the AI generates an electronic document in the at least one embodiment to a degree that the processing can be implemented based on the description of the at least one embodiment and the common general technical knowledge at the time of filing.

Further, the generation-related processing is not limited to the processing for generating an electronic document itself. The generation-related processing may be any processing relating to the generation of the electronic document in some way. For example, the generation-related processing may be pre-processing for generating an electronic document. The generation-related processing execution module 203 may execute processing for generating data such as a CSV file as the generation-related processing. In this case, the providing module 204 described later may generate an electronic document by importing data such as a CSV file into a default electronic document (electronic document template) and thereby providing the generated electronic document to the user. The data may have any format that enables the data to be imported into the electronic document, and is not limited to CSV.

As an example of the generation-related processing, processing for generating an API request for requesting the generation of the electronic document may be executed as the generation-related processing. The generation-related processing execution module 203 transmits the API request generated by the generation-related processing to the work support server 30. When the work support server 30 receives the API request, the work support server 30 may execute the API request to generate an electronic document. A program required for generating an electronic document may be attached to the API request, or may be stored in advance in the work support server 30. The work support server 30 may execute the program to generate an electronic document.

As an example of the generation-related processing, processing for generating code (for example, code in a programming language such as Python or code in a database language) for generating an electronic document may be executed as the generation-related processing. An example of such generation-related processing is described later in Modification Example 6.

The generation-related processing execution module 203 may input the input data including other information than the registration data and the user input information to the AI. For example, the AI may not be able to recognize, based on the user input information alone, what kind of electronic document is required to be generated or whether or not an electronic document is required to be generated in the first place, and hence a default prompt indicating that the AI is required to generate an electronic document may be provided. The default prompt is assumed to be stored in the data storage unit 200. For example, the default prompt indicates a sentence in a natural language such as “Please generate an electronic document based on the instruction of the user.” The default prompt may indicate the type of electronic document. The generation-related processing execution module 203 inputs the input data including such a default prompt to the AI. The AI can recognize what the AI itself is required to do by calculating the embedded representation corresponding to the default prompt.

### Providing Module

The providing module 204 provides the electronic document to the user. The providing module 204 providing the electronic document means that the providing module 204 transmits data of the electronic document to the user terminal 40. The providing module 204 may transmit the data of the electronic document directly to the user terminal 40, or may transmit the data of the electronic document indirectly through another computer such as the work support server 30. In the at least one embodiment, the electronic document is displayed on the browser of the user terminal 40, and hence a case in which the providing module 204 directly or indirectly transmits data (for example, HTML data) required for displaying the electronic document to the user terminal 40 is taken as an example.

In the at least one embodiment, the electronic document generated by the generation-related processing execution module 203 is deployed by the work support server 30 and then transmitted to the user terminal 40. The deployment is deployment to the electronic document in the environment of the work support system 1. Publicly-known processing may be used for the deployment itself of the electronic document. In the examples of FIG. 2 and FIG. 3, the deployment is development of the electronic document in an environment of the app selected by the user. For example, the providing module 204 requests the work support server 30 to deploy the electronic document generated by the generation-related processing execution module 203. When the work support server 30 receives the request for the deployment, the work support server 30 deploys the electronic document requested from the generation-related server 20. For example, the work support server 30 performs the deployment by embedding the data of the electronic document in the display data (for example, HTML data) of the work support screen SC. The electronic document may be embedded at any location in the display data. In the example in the lower half of FIG. 3, the electronic document is displayed in the display region A2 of the work support screen SC in a pop-up format, but the electronic document may be displayed in any other format.

For example, when the user confirms that an electronic document that meets his or her own wish has been generated, he or she performs an operation for saving the electronic document. In this case, the work support server 30 saves the electronic document in a data storage unit 300 in association with the user. The user can use the electronic document saved in the data storage unit 300. For example, when the user calls up again the app for which an electronic document has been generated by the AI, the electronic document is registered in the record in the display data of the work support screen SC of the app. The user can also modify or delete the electronic document saved in the data storage unit 300. The providing module 204 may transmit the electronic document to the user terminal 40 without saving the electronic document in the app. In this case, the user terminal 40 downloads and saves the electronic document provided by the providing module 204.

### 3-3. Functions Implemented in Work Support Server

For example, the work support server 30 includes the data storage unit 300 and a work support module 301. The data storage unit 300 is implemented by the storage unit 32. The work support module 301 is implemented by the control unit 31.

### Data Storage Unit

The data storage unit 300 stores data required for the work support processing. For example, the data storage unit 300 stores the work support database DB in which various kinds of data on the work support system 1 are stored. In the at least one embodiment, a scene in which the user extends the function of the app is taken as an example, and hence a case in which various kinds of data on the app are stored in the work support database DB is taken as an example.

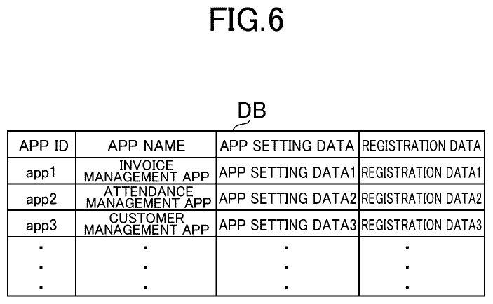

FIG. 6 is a table for showing an example of the work support database DB. For example, the work support database DB stores an app ID, an app name, app setting data, and registration data. The data stored in the work support database DB is not limited to the example of FIG. 6. For example, the work support database DB may store registration data on another work support function other than the app (for example, registration data on conversation threading in which users communicate with each other, registration data on schedules, or registration data on emails).

The app ID is an ID that can identify the app. The app name is a name of the app. The app setting data indicates the setting of the app designated by the user with no-code or low-code. For example, the app setting data may be the above-mentioned field setting, a graph setting, a display setting of the list L, an access right setting, or another setting. The code generated by the AI may be saved as part of the app setting data. The registration data can be registered, changed, or deleted by the user. In the at least one embodiment, a case in which the data of the record of the app corresponds to the registration data is taken as an example. When the user creates a new app, data such as the app ID of the new app is stored in the work support database DB. When the user updates the app, the registration data on the app in the work support database DB is updated.

For example, the data storage unit 300 stores a program for the work support function and actual data of each of the plurality of APIs. The actual data of each API includes: a program for performing various kinds of processing such as acquisition or transmission of data; and data including settings to be referred to by the program. The program for the work support function can also be called up through the processing of the program included in the actual data of the API. The actual data of the API may be similar to data employed in a publicly-known API. The data storage unit 300 may store data (for example, information that can identify the API endpoint of each of the plurality of APIs) required for the work support server 30 to receive the API request.

The data stored in the data storage unit 300 is not limited to the above-mentioned example. It suffices that the data storage unit 300 stores data required for supporting work. For example, the data storage unit 300 may store data (for example, HTML data or image data) required for displaying the work support screen SC, or may store data (for example, a deployment program) required for deploying the electronic document.

### Work Support Module

The work support module 301 executes the work support processing for supporting work of users. The work support processing is processing for providing the work support function to the user. For example, the work support processing is processing for displaying the work support screen SC on the user terminal 40. In the at least one embodiment, the electronic document generated by the generation-related server 20 is provided under the environment of the app, and hence the work support processing may be processing for deploying the electronic document generated by the AI and displaying the electronic document on the work support screen SC. Details of the processing for displaying the work support screen SC and the processing for deploying the electronic document generated by the AI are as described above.

### 3-4. Functions Implemented in User Terminal

For example, the user terminal 40 includes a data storage unit 400, a display control module 401, and an operation reception module 402. The data storage unit 400 is implemented by the storage unit 42. Each of the display control module 401 and the operation reception module 402 is implemented by the control unit 41.

### Data Storage Unit

The data storage unit 400 stores data for the work support. For example, the data storage unit 400 stores a browser for displaying various screens of the work support system 1. For example, the data storage unit 400 stores an application dedicated to the work support system 1. The data storage unit 400 stores the display data on the work support screen SC.

### Display Control Module

The display control module 401 displays various screens in the work support system 1 on the display unit 45. For example, the display control module 401 displays the work support screen SC on the display unit 45 based on data received from the voice conversion server 10, the generation-related server 20, or the work support server 30.

### Operation Reception Module

The operation reception module 402 receives various operations in the work support system 1. For example, the operation reception module 402 receives operations on the work support screen SC. Data indicating the operation content received by the operation reception module 402 is transmitted to the voice conversion server 10, the generation-related server 20, or the work support server 30 as appropriate.

### 4. Processing Executed in Work Support System

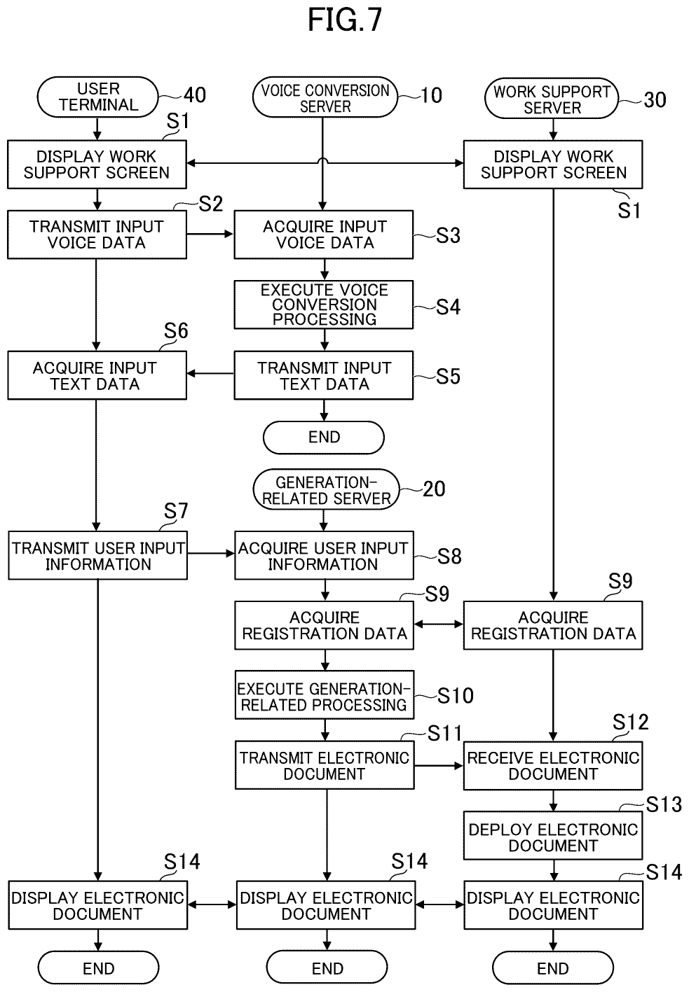

FIG. 7 is a flowchart for illustrating an example of processing executed in the work support system 1. The processing of FIG. 7 is executed by the control units 11, 21, 31, and 41 executing the programs stored in the storage units 12, 22, 32, and 42, respectively. Respective processing steps of FIG. 7 are examples of processing steps included in the work support method. In FIG. 7, an example of processing performed so as to generate an electronic document is illustrated. In FIG. 7, the user terminal 40 may communicate indirectly to/from each of the voice conversion server 10 and the generation-related server 20 through the work support server 30 instead of directly communicating to/from each thereof.

As illustrated in FIG. 7, the user terminal 40 executes, between the user terminal 40 and the work support server 30, the processing for displaying the work support screen SC of the app selected by the user (Step S1). In Step S1, the work support server 30 generates display data on the work support screen SC of the app selected by the user based on the work support database DB, and transmits the display data to the user terminal 40. When the user terminal 40 receives the display data on the work support screen SC, the user terminal 40 displays the work support screen SC on the display unit 45. After that, the user instructs the AI to generate an electronic document in accordance with a flow of FIG. 2 and FIG. 3.

When the user terminal 40 receives input of voice from the user through the voice input unit 46, the user terminal 40 transmits the input voice data indicating the voice input by the user to the voice conversion server 10 (Step S2). The voice conversion server 10 acquires the input voice data from the user terminal 40 (Step S3). The voice conversion server 10 executes the voice conversion processing based on the voice conversion program and the input voice data (Step S4). The voice conversion server 10 transmits the input text data indicating the text of the voice input by the user (Step S5). The user terminal 40 acquires the input text data from the voice conversion server 10 (Step S6).

When the user selects the button B1, the user terminal 40 transmits the user input information to the generation-related server 20 (Step S7). In Step S7, the user terminal 40 requests the generation-related server 20 to generate an electronic document. In Step S7, the app ID of the app for which an electronic document is to be generated is transmitted as well. The generation-related server 20 acquires the user input information and the like from the user terminal 40 (Step S8). The generation-related server 20 executes, between the generation-related server 20 and the work support server 30, processing for acquiring the registration data (Step S9). In Step S9, the generation-related server 20 identifies the record number of the record for which the user has instructed the generation of an electronic document based on the user input information. The generation-related server 20 transmits the record number to the work support server 30. The work support server 30 refers to the work support database DB to acquire the registration data that is the data of the record of the record number. The work support server 30 transmits the acquired registration data to the generation-related server 20. The generation-related server 20 acquires the registration data from the work support server 30.

The generation-related server 20 executes generation-related processing based on the AI and the input data including the user input information acquired in Step S8 and the registration data acquired in Step S9 (Step S10). In Step S10, the generation-related server 20 transmits the input data to the external system managing the AI. The generation-related server 20 acquires the output data including the electronic document generated by the AI from the external system. The generation-related server 20 transmits the electronic document generated in Step S10 to the work support server 30 (Step S11). The electronic document generated in Step S10 may be transmitted from the generation-related server 20 to the user terminal 40 and then transmitted to the work support server 30 by the user terminal 40.

The work support server 30 receives the electronic document from the generation-related server 20 (Step S12). The work support server 30 deploys the electronic document in the environment of the app (Step S13). The work support server 30 cooperates with the generation-related server 20 and the user terminal 40 to execute the processing for providing the electronic document to the user (Step S14), and the processing ends. The work support server 30 transmits the display data of the work support screen SC indicating the electronic document deployed in the environment of the app to the user terminal 40 through the generation-related server 20. When the user terminal 40 receives the display data on the work support screen SC, the user terminal 40 displays the work support screen SC on the display unit 45. When voice output of the answer from the AI is required, the voice conversion server 10 acquires data indicating the answer from the AI from the generation-related server 20, and executes the processing for converting text into voice. The converted voice is output by the user terminal 40.

### 5. Summary of at Least One Embodiment

The work support system 1 according to the at least one embodiment acquires the registration data registered in the work support system 1. The work support system 1 acquires the user input information based on the input of the user. The work support system 1 executes the generation-related processing based on the registration data, the user input information, and the AI. The work support system 1 provides the electronic document to the user. This enables the user to generate an electronic document through use of the AI even without creating a program for generating an electronic document, and hence the work support system 1 can increase the convenience of the user. For example, the user of the no-code or low-code work support system 1 may have no knowledge of programming languages or may not have much knowledge of programming languages. The user can easily generate an electronic document by electronic document generation processing of the work support system 1 even without acquiring knowledge of programming languages. The user with knowledge of programming languages does not require time and labor to create a program for generating an electronic document, and hence the work support system 1 can increase the convenience of the user with knowledge of programming languages. For example, a non-AI electronic document creation tool may be able to generate only limited electronic documents, and cannot meet various requests from users. The work support system 1 can meet various requests from users by utilizing the AI. The work support system 1 can generate an electronic document that enables customization that meets a specific request from each user.

### 6. Modification Examples

The present disclosure is not limited to the at least one embodiment described above. The present disclosure can be modified as required without departing from the purport of the present disclosure.

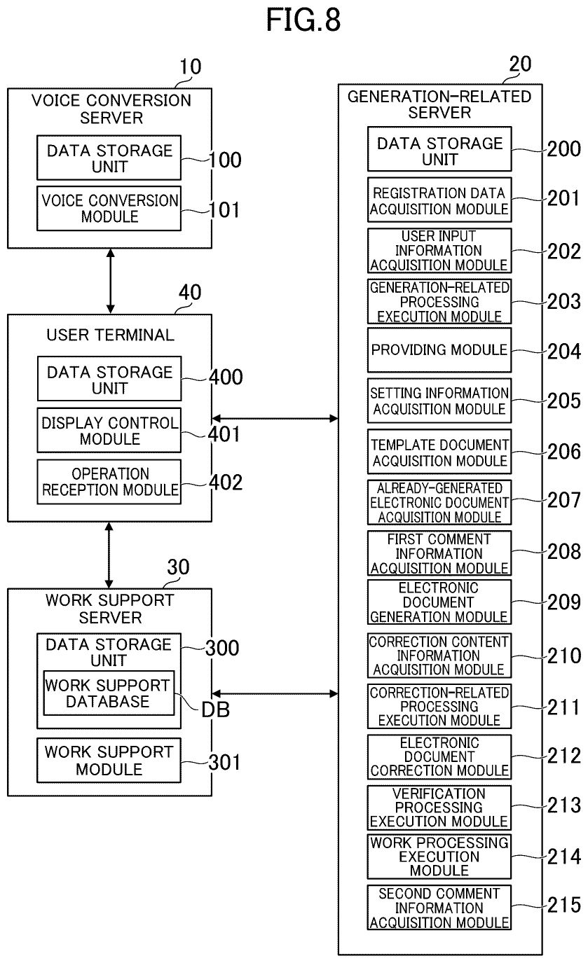

FIG. 8 is a diagram for illustrating an example of functions implemented in the work support system 1 according to modification examples. As illustrated in FIG. 8, in the modification examples described below, a setting information acquisition module 205, a template document acquisition module 206, an already-generated electronic document acquisition module 207, a first comment information acquisition module 208, an electronic document generation module 209, a correction content information acquisition module 210, a correction-related processing execution module 211, an electronic document correction module 212, a verification processing execution module 213, a work processing execution module 214, and a second comment information acquisition module 215 are implemented. Each of the setting information acquisition module 205, the template document acquisition module 206, the already-generated electronic document acquisition module 207, the first comment information acquisition module 208, the electronic document generation module 209, the correction content information acquisition module 210, the correction-related processing execution module 211, the electronic document correction module 212, the verification processing execution module 213, the work processing execution module 214, and the second comment information acquisition module 215 is implemented by the control unit 21.

### 6-1. Modification Example 1

For example, depending on the registration data, there may be a setting specific to the registration data. Assuming that, as in the at least one embodiment, the record of the app corresponds to the registration data, the registration data may have a setting such as a field name of the record. When the setting of the registration data is recognized by the AI, accuracy of the generation-related processing may be increased. For example, the AI may be able to generate an electronic document corresponding to the setting such as the field name. In view of this, in Modification Example 1, a case in which setting information relating to the setting of the registration data is used in the generation-related processing is taken as an example.

The work support system 1 according to Modification Example 1 includes the setting information acquisition module 205. The setting information acquisition module 205 acquires the setting information relating to the setting of the registration data.

The setting information may be any information that relates to the setting of the registration data. For example, the setting information may indicate identification information such as a name or an ID of the registration data, a type (format), a data size, an extension, an access right, supplementary information such as a calculation formula, a layout at a time of display, or another setting. In Modification Example 1, a case in which the record of the app corresponds to the registration data is taken as an example, and hence the setting information is information relating to the setting of the record. In addition, a case in which the information relating to the field setting corresponds to the setting information is taken as an example.

The field is each individual item that forms a record. The record is each individual unit of data in the app. The field may also be called by another name such as a cell. For example, the setting information may indicate a field name that is a name of the field, a field code that is a code of the field, a field type that is a type of the field, a calculation formula associated with the field, a sequential order of the field, a position of an input form for the user to input a value of the field, a design of the field on the work support screen SC, an access right to the field, or another setting. The setting information may indicate a plurality of settings among those. The setting information may be able to be designated by the user, or may not be able to be designated by the user.

For example, when the user selects the button B1 with the text having been input in the input form F of the work support screen SC, the setting information acquisition module 205 acquires an app ID of the app selected by the user from the user terminal 40. The app ID is assumed to be included in display data (for example, HTML data) on the work support screen SC. The app ID may be included as part of a URL (for example, an argument included in a link for the button B1). It suffices that the setting information acquisition module 205 acquires the app ID of the app for which an electronic document is to be generated in some way. The setting information acquisition module 205 may acquire the app ID of the app selected by the user from the voice conversion server 10, the work support server 30, or another computer.

For example, the setting information acquisition module 205 requests the work support server 30 for the setting information based on the app ID of the app selected by the user. It is assumed that the request includes the app ID. When the work support server 30 receives the request, the work support server 30 refers to the work support database DB to acquire setting information associated with the app ID. In the data storage example of FIG. 6, the setting information is assumed to be included in the app setting data. The app setting data may include information on other settings such as settings of the app itself in addition to the setting information that is the field setting. In Modification Example 1, the setting information that is the field setting is assumed to be acquired from within the app setting data. The work support server 30 transmits the setting information to the generation-related server 20. The setting information acquisition module 205 acquires the setting information from the work support server 30.

The setting information may indicate the setting of the app itself in place of the field of the app. For example, the setting information may be an app name that is a name of the app, a note for an administrator of the app, a display format of the list L, an icon of the app, a design of the app, a setting of a workflow, a notification setting, a plug-in added to the app, a function extended by a script, CSS, or the like, an access right, or a hierarchical format of records.

For example, when an electronic document is generated based on another piece of registration data other than the record of the app, the setting information acquisition module 205 is only required to acquire setting information on the other piece of registration data. When the data storage unit 200 stores the setting information, the setting information acquisition module 205 may acquire the setting information from the data storage unit 200. The setting information acquisition module 205 may acquire the setting information from another computer (for example, the user terminal 40) other than the generation-related server 20 and the work support server 30 or an external information storage medium.

The generation-related processing execution module 203 in Modification Example 1 executes the generation-related processing further based on the setting information. The phrase “further based on the setting information” means that the subject is based on not only the registration data, the user input information, and the AI but also the setting information. For example, the generation-related processing execution module 203 inputs the input data including the setting information to the AI. The AI calculates the embedded representation based on not only the registration data and the user input information but also the setting information. The embedded representation reflects not only the registration data and the user input information but also the setting information. The AI outputs the output data including the electronic document corresponding to the calculated embedded representation. The generation-related processing execution module 203 acquires the electronic document included in the output data output by the AI. For example, the AI identifies what kind of electronic document is to be generated based on the embedded representation corresponding to the setting information, and generates an electronic document.

The generation-related processing in Modification Example 1 is not limited to the processing for generating an electronic document further based on the setting information. The generation-related processing in Modification Example 1 may be other processing as in the at least one embodiment. For example, the generation-related processing execution module 203 may execute the generation-related processing by generating data such as a CSV file further based on the setting information and importing the data into a default electronic document. The generation-related processing execution module 203 may execute the generation-related processing by generating an API request for requesting the generation of an electronic document further based on the setting information. The generation-related processing execution module 203 may execute the generation-related processing by generating code for the generation of an electronic document further based on the setting information.

The work support system 1 according to Modification Example 1 executes the generation-related processing further based on the setting information. This enables the work support system 1 to generate an electronic document specific to the setting of the registration data. For example, when a field name is indicated in the setting information, the work support system 1 can generate an electronic document that matches the field name, thereby increasing accuracy of the electronic document. When a purpose of the app is indicated in the setting information, the work support system 1 can generate an electronic document that matches the purpose, thereby increasing the accuracy of the electronic document.

### 6-2. Modification Example 2

For example, when an electronic document template is input to the AI, the AI can output the output data that conforms to a template. In view of this, in Modification Example 2, a case in which the electronic document template is used in the generation-related processing is taken as an example. The electronic document template is hereinafter referred to as “template document.” The work support system 1 according to Modification Example 2 includes the template document acquisition module 206. The template document acquisition module 206 acquires a template document relating to the electronic document, the template document being provided in advance.

In Modification Example 2, the data storage unit 200 stores the template document. For example, the data storage unit 200 may store a template database in which an index to be used in searching for each template document is associated with the template document. The index may be a keyword or the like for searching for a template document. The template document may be provided by any person. For example, an operator of the work support system 1 or the user may provide the template document. An electronic document created by the user in the past may be used as the template document.

For example, the template document acquisition module 206 acquires the template document from the template database. The template document acquisition module 206 may search the template database through use of the user input information as a query, and acquire a template document hit by the search. When the search is not particularly used, the template document acquisition module 206 may acquire a template document selected by the user from among a plurality of template documents. When there is only one template document, the template document acquisition module 206 may acquire the template document without the search, the selection, or the like.

The template document may be stored in a location other than the template database. For example, the template document acquisition module 206 may acquire the template document from another database other than the template database, another computer (for example, the work support server 30) other than the generation-related server 20, or an external information storage medium. The template document acquisition module 206 may acquire only one template document, or may a acquire plurality of template documents.

The generation-related processing execution module 203 in Modification Example 2 executes the generation-related processing further based on the template document. The phrase “further based on the template document” means that the subject is based on not only the registration data, the user input information, and the AI but also the template document. For example, the generation-related processing execution module 203 inputs the input data including the template document to the AI. The AI calculates the embedded representation based on not only the registration data and the user input information but also the template document. The embedded representation reflects not only the registration data and the user input information but also the template document. The AI outputs the output data including the electronic document corresponding to the calculated embedded representation. The generation-related processing execution module 203 acquires the electronic document included in the output data output by the AI. For example, the AI identifies what kind of electronic document is to be generated based on the embedded representation corresponding to the template document, and generates an electronic document.

The generation-related processing in Modification Example 2 is not limited to the processing for generating an electronic document further based on the template document. The generation-related processing in Modification Example 2 may be other processing as in the at least one embodiment. For example, the generation-related processing execution module 203 may execute the generation-related processing by generating data such as a CSV file further based on the template document and importing the data into the template document. The generation-related processing execution module 203 may execute the generation-related processing by generating an API request for requesting the generation of an electronic document further based on the template document. The generation-related processing execution module 203 may execute the generation-related processing by generating code for the generation of an electronic document further based on the template document.

The work support system 1 according to Modification Example 2 executes the generation-related processing further based on the template document. This enables the work support system 1 to generate an electronic document specific to the template document. In the examples of FIG. 2 and FIG. 3, the invoice serving as a template is provided as the template document. The AI outputs the output data with the invoice serving as a template being used as a reference. This enables the work support system 1 to generate an invoice that conforms to the invoice serving as a template. Similarly when another electronic document other than the invoice is generated, the work support system 1 can increase accuracy of the other electronic document.

### 6-3. Modification Example 3

For example, when an electronic document is generated based on a certain piece of registration data, another piece of registration data may serve as a reference. In a case of such an invoice as in FIG. 2 and FIG. 3, detailed information on an invoice recipient may not be registered in the invoice management app selected by the user. When the detailed information on the invoice recipient is registered in a customer management app, which is another app other than the invoice management app, it may be more appropriate to use not only the registration data in the invoice management app but also another piece of registration data in the customer management app. In view of this, in Modification Example 3, a case in which another piece of registration data is used in the generation of an electronic document is taken as an example.

The registration data acquisition module 201 in Modification Example 3 acquires selected registration data, which is a piece of registration data selected by the user, and related registration data, which is another piece of registration data relating to the piece of registration data, from among a plurality of pieces of registration data. The selected registration data is the registration data described in the at least one embodiment. For example, the record of the app selected by the user corresponds to the selected registration data. The related registration data is another piece of registration data associated with the selected registration data. For example, the related registration data may be another record of the same app, or may be a record of another app.

It is assumed that definition data that defines which piece of selected registration data and which piece of related registration data relate to each other is stored in advance in the data storage unit 200. The registration data acquisition module 201 acquires the related registration data based on the definition data. In the examples of FIG. 2 and FIG. 3, the definition data defines in advance that the invoice management app and the customer management app are associated with each other. The registration data acquisition module 201 can identify, based on the definition data, that it is only required to acquire a record of the customer management app as the related registration data. For example, the registration data acquisition module 201 searches the customer management app with the value of the field “invoice recipient” included in the registration data being used as a key, and acquires, as the related registration data, a record of the customer management app hit by the search. It is assumed that which field is to be used as the key is determined in advance.

In Modification Example 5, the related registration data is assumed to be stored in the work support database DB. The registration data acquisition module 201 identifies the related registration data based on the app ID of the app selected by the user and the related registration data. The registration data acquisition module 201 requests the work support server 30 for the related registration data. The request is assumed to include the app ID of the app in which the related registration data is registered.

For example, when the work support server 30 receives the request, the work support server 30 refers to the work support database DB to acquire the related registration data associated with the app ID. The work support server 30 transmits the related registration data to the generation-related server 20. The registration data acquisition module 201 acquires the related registration data from the work support server 30. The related registration data may be identified by the work support server 30 instead of being identified by the generation-related server 20. In this case, the data storage unit 300 stores the related registration data. It suffices that the work support server 30 acquires, from the generation-related server 20, the app ID of the app for which an electronic document is to be generated, and identifies the related registration data based on the app ID and the related registration data.

The generation-related processing execution module 203 in Modification Example 3 executes the generation-related processing based on the selected registration data and the related registration data. The generation-related processing execution module 203 inputs, to the AI, the input data including not only the selected registration data but also the related registration data as the registration data. The AI calculates the embedded representation based on not only the selected registration data and the user input information but also the related registration data. The embedded representation reflects not only the selected registration data and the user input information but also the related registration data. The AI outputs the output data including the electronic document corresponding to the calculated embedded representation. The generation-related processing execution module 203 acquires the electronic document included in the output data output by the For example, the AI identifies what kind of electronic AI. document is to be generated based on the embedded representation corresponding to the related registration data, and generates an electronic document.

The generation-related processing in Modification Example 3 is not limited to the processing for generating an electronic document based on the selected registration data and the related registration data. The generation-related processing in Modification Example 3 may be other processing as in the at least one embodiment. For example, the generation-related processing execution module 203 may execute the generation-related processing by generating data such as a CSV file based on the selected registration data and the related registration data and importing the data into a default electronic document. The generation-related processing execution module 203 may execute the generation-related processing by generating an API request for requesting the generation of an electronic document based on the selected registration data and the related registration data. The generation-related processing execution module 203 may execute the generation-related processing by generating code for the generation of an electronic document based on the selected registration data and the related registration data. The work support system 1 according to Modification Example 3 executes the generation-related processing based on the selected registration data and the related registration data. This enables the work support system 1 to generate an electronic document specific to the related registration data. In the examples of FIG. 2 and FIG. 3, when the detailed information on the invoice recipient is not registered in the invoice management app, the work support system 1 can acquire the detailed information on the invoice recipient from the related registration data registered in the customer management app and generate a more appropriate electronic document.

### 6-4. Modification Example 4

For example, a user may wish to generate an electronic document in the same format as that of an already-generated electronic document generated in the past. When the user repeatedly issues an invoice to the same invoice recipient, the user may wish to issue an invoice in the same format as that of an already-generated invoice issued in the past to that invoice recipient. Even when the invoice recipient is not the same, the user may wish to issue an invoice in the same format as that of the already-generated invoice. In view of this, in Modification Example 3, a case in which the already-generated electronic document is used in the generation of an electronic document is taken as an example. In Modification Example 3, it is assumed that the user is capable of repeatedly executing the generation-related processing.

The work support system 1 according to Modification Example 4 includes the already-generated electronic document acquisition module 207. The already-generated electronic document acquisition module 207 acquires the already-generated electronic document generated by the generation-related processing executed in the past. For example, the data storage unit 200 stores the already-generated electronic document. The already-generated electronic document is stored in the data storage unit 200 in association with the user who instructed the generation of an electronic document. The already-generated electronic document may be stored in the data storage unit 200 in association with a delivery destination of the electronic document (in the examples of FIG. 2 and FIG. 3, the invoice recipient). The already-generated electronic document may be stored in the data storage unit 200 in association with the app for which the electronic document has been generated. When the generation-related processing is executed, the generation-related server 20 records the already-generated electronic document in the data storage unit 200.

For example, the already-generated electronic document acquisition module 207 acquires the already-generated electronic document from the data storage unit 200. The already-generated electronic document acquisition module 207 may acquire the already-generated electronic document associated with the user who has instructed the generation of a new electronic document. The already-generated electronic document acquisition module 207 may acquire the already-generated electronic document associated with the delivery destination of a new electronic document. The already-generated electronic document acquisition module 207 may acquire the already-generated electronic document associated with the app for which a new electronic document is to be generated. The already-generated electronic document acquisition module 207 may acquire the already-generated electronic document from another computer (for example, the work support server 30) other than the generation-related server 20, or an external information storage medium.

The generation-related processing execution module 203 in Modification Example 4 executes the generation-related processing further based on the already-generated electronic document. The phrase “further based on the already-generated electronic document” means that the subject is based on not only the registration data, the user input information, and the AI but also the already-generated electronic document. For example, the generation-related processing execution module 203 inputs the input data including the already-generated electronic document to the AI. The AI calculates the embedded representation based on not only the registration data and the user input information but also the already-generated electronic document. The embedded representation reflects not only the registration data and the user input information but also the already-generated electronic document. The AI outputs the output data including the electronic document corresponding to the calculated embedded representation. The generation-related processing execution module 203 acquires the electronic document included in the output data output by the AI. For example, the AI identifies what kind of electronic document is to be generated based on the embedded representation corresponding to the already-generated electronic document, and generates an electronic document.

The generation-related processing in Modification Example 4 is not limited to the processing for generating an electronic document further based on the already-generated electronic document. The generation-related processing in Modification Example 4 may be other processing as in the at least one embodiment. For example, the generation-related processing execution module 203 may execute the generation-related processing by generating data such as a CSV file further based on the already-generated electronic document and importing the data into a default electronic document. The generation-related processing execution module 203 may execute the generation-related processing by generating an API request for requesting the generation of an electronic document further based on the already-generated electronic document. The generation-related processing execution module 203 may execute the generation-related processing by generating code for the generation of an electronic document further based on the already-generated electronic document.

The work support system 1 according to Modification Example 4 executes the generation-related processing further based on the already-generated electronic document. This enables the work support system 1 to generate an electronic document specific to the already-generated electronic document. In the examples of FIG. 2 and FIG. 3, an already-generated invoice issued by the user in the past is present as the already-generated electronic document. The AI outputs the output data with the already-generated invoice being used as a reference. This enables the work support system 1 to generate an invoice that conforms to the already-generated invoice. Similarly when another electronic document other than the invoice is generated, the work support system 1 can increase accuracy of the other electronic document.

### 6-5. Modification Example 5

For example, the app has not only the database function but also the communication function, and hence the user can register any comment in the record of the app. The user can communicate with another user by registering a comment. In the examples of FIG. 2 and FIG. 3, the user communicates with another user by registering a comment about content of work relating to issuance of an invoice. Such a comment may be useful in the generation of an electronic document. In view of this, in Modification Example 5, a case in which the comment is used in the generation-related processing is taken as an example.

The work support system 1 includes the first comment information acquisition module 208. The first comment information acquisition module 208 acquires comment information relating to a comment associated with the registration data. The comment information is text in a natural language indicating content of the comment. The comment can also be said to be a post of the user. The comment associated with the registration data refers to a comment input on the work support screen SC indicating the registration data. In other words, a comment that can be searched for from the registration data corresponds to the comment associated with the registration data.

In Modification Example 5, the comment information is assumed to be stored in the work support database DB. For example, the first comment information acquisition module 208 acquires the comment information from the work support database DB. The first comment information acquisition module 208 is only required to acquire the comment information from the work support database DB in the same manner as the registration data acquisition module 201 acquires the registration data. The first comment information acquisition module 208 may acquire the comment information from another database other than the work support database DB, another computer other than the work support server 30, or an external information storage medium.

The generation-related processing execution module 203 in Modification Example 5 executes the generation-related processing further based on the comment information. The phrase “further based on the comment information” means that the subject is based on not only the registration data, the user input information, and the AI but also the comment information. For example, the generation-related processing execution module 203 inputs the input data including the comment information to the AI. The AI calculates the embedded representation based on not only the registration data and the user input information but also the comment information. The embedded representation reflects not only the registration data and the user input information but also the comment information. The AI outputs the output data including the electronic document corresponding to the calculated embedded representation. The generation-related processing execution module 203 acquires the electronic document included in the output data output by the AI. For example, the AI identifies what kind of electronic document is to be generated based on the embedded representation corresponding to the comment information, and generates an electronic document.

The generation-related processing in Modification Example 5 is not limited to the processing for generating an electronic document further based on the comment information. The generation-related processing in Modification Example 5 may be other processing as in the at least one embodiment. For example, the generation-related processing execution module 203 may execute the generation-related processing by generating data such as a CSV file further based on the comment information and importing the data into a default electronic document. The generation-related processing execution module 203 may execute the generation-related processing by generating an API request for requesting the generation of an electronic document further based on the comment information. The generation-related processing execution module 203 may execute the generation-related processing by generating code for the generation of an electronic document further based on the comment information.

The work support system 1 according to Modification Example 5 executes the generation-related processing further based on the comment information. This enables the work support system 1 to generate an electronic document specific to the comment information. For example, when the user has commented on a layout of an electronic document in a record of a certain app, the work support system 1 can generate an electronic document that conforms to the layout desired by the user. When the user has commented on an item that the user wishes to include in an electronic document, the work support system 1 can generate an electronic document that includes the item desired by the user.

### 6-6. Modification Example 6

For example, as described to some degree in the at least one embodiment and Modification Examples 1 to 5, the generation-related processing execution module 203 may execute code generation processing for generating code relating to the generation of an electronic document as the generation-related processing. The code to be generated by the code generation processing is only required to be code in a programming language that can be executed by the work support system 1, and may be code in any such programming language. For example, the Python library is provided with a library for the generation of an electronic document, and hence the code generation processing may be processing for generating code that uses the library. For another example, code for the generation of an electronic document is also provided in another programming languages such as JavaScript (trademark) or C language, and hence the code generation processing may be processing for generating such code.

For example, the generation-related processing execution module 203 inputs the input data to the AI in the same manner as in the at least one embodiment. The user input information may indicate that the AI is required to generate code. A default prompt indicating that the AI is required to generate code may be provided in advance. The default prompt is assumed to be stored in the data storage unit 200. The default prompt may be provided by an administrator of the work support system 1, or may be provided by the user. The AI can recognize that the AI is required to generate code for the generation of an electronic document based on at least one of the user input information or the default prompt.

The AI calculates the embedded representation of the input data, and outputs the output data including the code corresponding to the embedded representation. When GPT is used as the AI, a function called a code interpreter provided in the GPT may be used to generate code. The output data of the AI may include information to which the code is to refer in order to generate an electronic document (such as information on a statement in the invoice in the example of the invoice in the lower half of FIG. 3). The AI generating code for the generation of an electronic document based on the registration data of the work support system 1 is a novel configuration at the time of filing, but a technology publicly known at the time of filing may be used as a technology itself for the AI to generate code for the generation of an electronic document. Thus, a person skilled in the art can understand the processing in which the AI generates code for the generation of an electronic document in the at least one embodiment to a degree that the processing can be implemented based on the description of the at least one embodiment and the common technical knowledge at the time of filing.

The work support system 1 according to Modification Example 6 includes the electronic document generation module 209. The electronic document generation module 209 generates an electronic document based on the code generated by the code generation processing. For example, the electronic document generation module 209 executes the code generated by the code generation processing to generate an electronic document corresponding to the registration data and user input information. The code may indicate not only the processing for generating an electronic document but also information to be included in the electronic document, or the information may be attached to the code. The electronic document generation module 209 generates an electronic document by executing such code. The processing itself for generating an electronic document based on the code may be publicly-known processing. For example, at least one of the above-mentioned Python library or code provided in another programming language may be used.

The work support system 1 according to Modification Example 6 executes the code generation processing for generating code relating to the generation of an electronic document as the generation-related processing. The work support system 1 generates an electronic document based on the code generated by the code generation processing. Accordingly, even when the AI does not have the function of generating an electronic document itself, as long as the AI has a function of generating code for the generation of an electronic document, the work support system 1 can provide the electronic document to the user.

### 6-7. Modification Example 7

For example, as described to some degree in the at least one embodiment, the providing module 204 may provide the electronic document to the user by executing processing for displaying, on the user terminal 40 of the user, a screen that allows the user to correct the electronic document based on a deployment result of the electronic document. The deployment result is a result of the processing for deploying the electronic document in the environment of the work support system 1. In the example in the lower half of FIG. 3, the work support screen SC including the display region A2 corresponds to the screen that allows the user to correct the electronic document. The screen may be another screen other than the work support screen SC such as in the lower half of FIG. 3. For example, the electronic document may be displayed on the entire screen instead of being displayed in a window such as the display region A2.

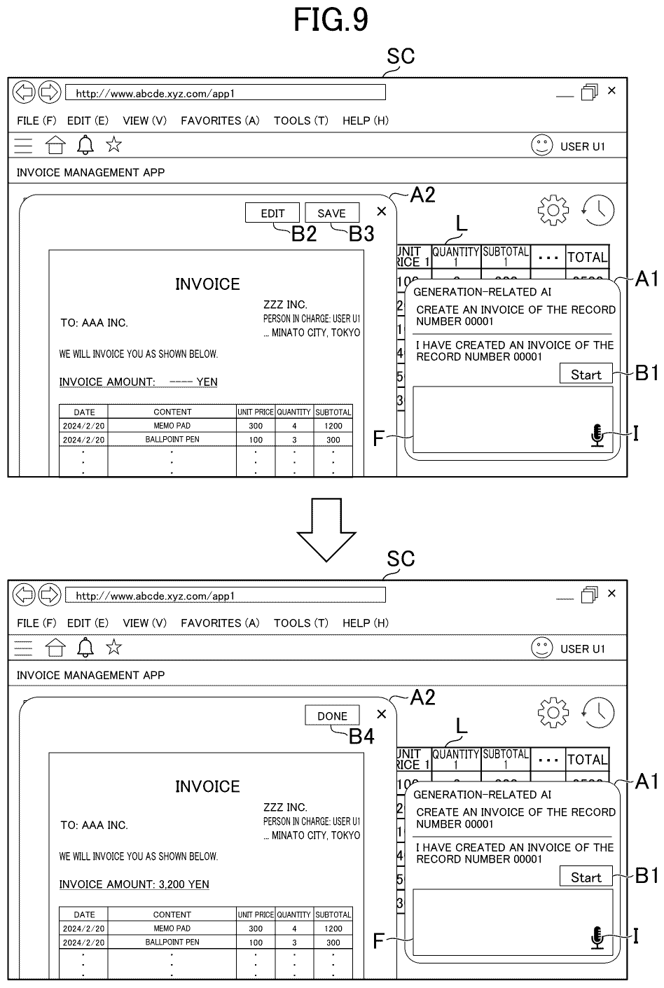

FIG. 9 is a view for illustrating an example of how the user corrects the electronic document. As in the upper half of FIG. 9, when the user selects the button B2, the providing module 204 shifts the work support screen SC to an edit mode for the electronic document. A program used in a publicly-known document editor may be used to edit the electronic document. The providing module 204 executes processing for the user to edit the electronic document based on the program. In the example in the upper half of FIG. 9, the AI was unable to generate a total amount of money of the invoice, and hence the user manually inputs the total amount of money.

For example, as in the lower half of FIG. 9, when the user inputs correction content and selects a button B4, the providing module 204 receives data indicating the correction content input by the user from the user terminal 40. The providing module 204 changes at least a portion of the electronic document based on the data. The providing module 204 transmits the electronic document subjected to the change to the user terminal 40. The user terminal 40 displays the electronic document subjected to the change on the work support screen SC. For example, the user terminal 40 displays the electronic document including the total amount of money input by the user on the work support screen SC. The providing module 204 may execute the above-mentioned series of processing through use of a publicly-known document editor.

The work support system 1 according to Modification Example 7 provides the electronic document to the user by executing processing for displaying, on the user terminal 40, the work support screen SC that allows the user to correct the electronic document based on the deployment result of the electronic document. This enables the user to correct the electronic document generated by the work support system 1, and hence the work support system 1 can further increase the convenience of the user.

### 6-8. Modification Example 8

For example, the AI may not be able to generate an electronic document that meets the wish of the users at once. For that reason, the user may be able to give an instruction to correct the electronic document generated by the AI. In the examples of FIG. 2 and FIG. 3, the user may give an instruction to correct the electronic document generated by the AI from the work support screen SC in the lower half of FIG. 3. In Modification Example 8, a case in which the user gives an instruction to correct the electronic document by voice input is taken as an example, but the user may give an instruction to correct the electronic document by any other input method. For example, the user may give an instruction to correct the electronic document by text input. For example, when the total amount of money listed on the third line of the invoice is incorrect or missing, the user may input an instruction such as “Please correct the third line.”

The user may explicitly instruct the work support system 1 to correct the electronic document by voice input, text input, or another operation (for example, by selecting a “Correct” button). The work support system 1 can identify, based on the explicit instruction from the user, that the already-generated electronic document is to be corrected rather than a new electronic document is to be generated. Even when the user does not give an explicit instruction, the AI may infer that the electronic document is to be corrected. The AI may identify, based on the input data, that the already-generated electronic document is to be corrected rather than a new electronic document is to be generated. The AI can perform such identification through use of the embedded representation of the input data.

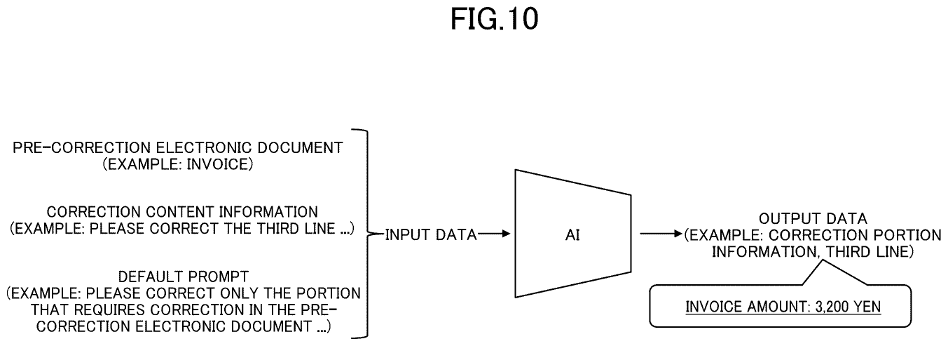

FIG. 10 is a diagram for illustrating an example of processing for the correction of the electronic document. The work support system 1 according to Modification Example 8 includes the correction content information acquisition module 210, the correction-related processing execution module 211, and the electronic document correction module 212. The correction content information acquisition module 210 acquires correction content information relating to correction content of the electronic document based on the input of the user. The correction content information is an instruction indicated by the input of the user at a time of the correction of the electronic document. The correction content information can also be said to be the intention of the user at the time of the correction. The correction content information may also be called a prompt for the AI. As in FIG. 10, at the time of the correction, the input data including the correction content information is input to the AI.

In Modification Example 8, a case in which text input in the input form F when the user selects the button B1 at the time of the correction of the electronic document corresponds to the correction content information is taken as an example. Thus, the correction content information is text indicating specific content with which the user wishes to correct the electronic document. When the user selects the button B1, the user terminal 40 transmits the correction content information, which is the text input in the input form F, to the generation-related server 20. The correction content information acquisition module 210 acquires the correction content information from the user terminal 40. The correction content information acquisition module 210 may acquire only one piece of correction content information, or may acquire a plurality of pieces of correction content information.

The correction content information may not be text in a natural language but may be the voice itself that has been used in the input by the user. In this case, the correction content information acquisition module 210 may acquire the correction content information, which is the voice, from the user terminal 40 and then request the voice conversion server 10 to convert the correction content information into text. The correction content information acquisition module 210 acquires the correction content information converted into text from the voice conversion server 10. The correction content information acquisition module 210 may acquire the correction content information indirectly through the voice conversion server 10, the work support server 30, or another computer, instead of acquiring the correction content information directly from the user terminal 40.

The correction-related processing execution module 211 generates correction portion information relating to post-correction content of a correction portion corresponding to the correction content in the electronic document, based on the correction content information and the AI. The correction portion corresponding to the correction content is a portion in the pre-correction electronic document. An amount of the correction portion varies depending on the correction content.

For example, the correction portion may be only one item, or may be two or more items, in the electronic document. The correction portion may not be a certain set of consecutive portions. For example, the 3rd and 10th lines of 20-line electronic document may be the correction portions. Which portion is to be corrected is determined by the AI. The correction portion may be only some items of one line.

For example, the AI outputs, together with the correction portion information, correction portion identification information that can identify the correction portion in the pre-correction electronic document. The correction portion identification information can also be said to be a location of the correction portion in the pre-correction electronic document. For example, the correction portion identification information indicates which line the correction portion is on. As the default prompt at the time of the correction, a prompt such as “Please correct only the portion that requires correction in the pre-correction electronic document. Please output the post-correction correction portion information of that portion and the identification information on that portion.” may be provided. Such a default prompt enables the AI to more accurately understand that it is only required to output the correction portion and the correction portion identification information.

For example, the correction-related processing execution module 211 inputs the input data including the pre-correction electronic document and the correction content information to the AI. In the example of FIG. 10, the correction-related processing execution module 211 inputs the input data further including the pre-correction electronic document to the AI. The AI calculates the embedded representation based on not only the correction content information but also the pre-correction electronic document. The embedded representation reflects not only the correction content information but also the pre-correction electronic document. The AI outputs the output data including the correction portion information and the correction portion identification information corresponding to the calculated embedded representation. The correction-related processing execution module 211 acquires the correction portion information and the correction portion identification information included in the output data output by the AI. In the example of FIG. 10, only the portion of the third line of the pre-correction electronic document is output from the AI as the correction portion information. The correction portion identification information indicates that the correction portion is on the third line.

The electronic document correction module 212 corrects the electronic document by replacing the correction portion in the electronic document by the correction portion information. The replacement can also be said to be overwriting or change. In the example of FIG. 10, the third line of the pre-correction electronic document is replaced by the correction portion data. For example, the electronic document correction module 212 replaces the correction portion indicated by the correction portion identification information in the pre-correction electronic document by the correction portion data. The user may designate the correction portion. For example, the user may perform input such as “Please correct the third line.” In this case, the correction content information includes the correction portion identification information. The AI is not required to output the correction portion identification information. Even when the AI does not output the correction portion identification information, the electronic document correction module 212 is only required to replace the correction portion input by the user by the correction portion information.

The work support system 1 according to Modification Example 8 acquires the correction content information based on the input of the user. The work support system 1 executes the correction-related processing based on the correction content information and the AI. The work support system 1 corrects the electronic document by replacing the correction portion in the electronic document by the correction portion information. This enables the work support system 1 to increase the efficiency of a correction task for the electronic document performed by the user, thereby increasing the convenience of the user at the time of the correction. For example, when the AI regenerates the entire electronic document, there is a possibility that an electronic document indicating completely different processing from before the correction may be generated, but the work support system 1 replaces only the correction portion in the pre-correction electronic document by the correction portion information, thereby preventing the electronic document from becoming completely different from that before the correction, and increasing accuracy of the correction.

### 6-9. Modification Example 9

For example, the AI may not be able to generate an electronic document that meets the wish of the user. The user may verify the electronic document generated by the AI. In Modification Example 9, a case in which processing for supporting verification work for the electronic document performed by the user is executed is taken as an example. The work support system 1 according to Modification Example 9 includes the verification processing execution module 213. The verification processing execution module 213 executes, when the electronic document has been generated, verification processing relating to the verification of the electronic document. The verification processing is processing for supporting the verification of the electronic document performed by the user. The verification of the electronic document refers to a check on whether the electronic document is correct or incorrect.

For example, the verification processing may be processing for identifiably displaying pieces of information included in the electronic document among pieces of registration data. In the example in the lower half of FIG. 3, the values of the respective fields of the registration data of the record number 00001 are included in the electronic document, and hence the verification processing execution module 213 may execute the verification processing by changing a color of the record of the record number 00001 in the list L. For example, the verification processing execution module 213 transmits HTML data including code indicating the color subjected to the change. The verification processing execution module 213 may enable identification of which record includes information used in the electronic document by displaying only the record on the work support screen SC instead of changing the color of the record.

For example, the verification processing may be processing for identifiably displaying a portion of registration data in the electronic document. In the example in the lower half of FIG. 3, the registration data is used for portions in the invoice, which exemplifies the electronic document, including the name of the invoice recipient, an invoice amount, and the statement. The other portions have been generated by the AI. Thus, the verification processing execution module 213 may execute the verification processing by changing the color of the portions in the electronic document for which the registration data has been used. The verification processing execution module 213 may execute the verification processing by applying another effect, such as underlining, instead of changing the color of the portions.

The verification processing is not limited to the above-mentioned example. The verification processing may be any processing for supporting the verification of the electronic document performed by the user. For example, when the AI generates an electronic document based on the registration data and a learned calculation formula, the verification processing execution module 213 may execute the verification processing by acquiring information on the calculation formula from the AI and displaying the calculation formula on the work support screen SC. The verification processing execution module 213 may execute the verification processing by determining whether or not there are any items missing in the electronic document based on items included in the electronic document generated by the AI and items defined in advance and displaying an execution result of the determination on the work support screen SC.

The work support system 1 according to Modification Example 9 executes, when the electronic document has been generated, the verification processing relating to the verification of the electronic document. This enables the work support system 1 to support the verification of the electronic document performed by the user, thereby being able to further increase the convenience of the user.

### 6-10. Modification Example 10

In the exemplary case described in the at least one embodiment, the providing module 204 displays the electronic document on the work support screen SC, thereby providing the electronic document to the user. The user uses the electronic document displayed on the work support screen SC in his or her own work. In Modification Example 10, an example of work performed by the user through use of the electronic document is described. In addition, a case in which the work support system 1 executes processing for support of the work is taken as an example.

The work support system 1 according to Modification Example 10 includes the work processing execution module 214. When the electronic document has been generated, the work processing execution module 214 executes work processing relating to work in which the electronic document is used. The work processing is processing for the support of the work relating to the electronic document. For example, the work processing may be processing for notifying that an electronic document has been generated, processing for changing a status of a work flow, processing for leaving a comment indicating that an electronic document has been generated, processing for registering an electronic document in a specified folder, processing for causing the user terminal 40 to download an electronic document, or other processing. In Modification Example 10, the processing for notifying that an electronic document has been generated is described as an example of the work processing.

For example, when the electronic document has been generated, the work processing execution module 214 notifies a notification destination defined in advance that an electronic document has been generated. The notification may be performed by any means. For example, the notification may be performed by a notification function (in the examples of FIG. 2 and FIG. 3, a function of displaying a notification from a bell-shaped icon) on the work support system 1, an email, a short message service (SMS), a message app, a push notification, a badge, or other means. It is assumed that data indicating the notification destination is stored in advance in the data storage unit 200.

For example, the notification destination may be a superior or a colleague of the user who has asked the user to generate the electronic document. When the electronic document has been generated, the work processing execution module 214 executes the work processing by performing the notification that an electronic document has been generated based on the data indicating the notification destination.

The work support system 1 according to Modification Example 10 executes, when the electronic document has been generated, the work processing relating to the work in which the electronic document is used. This enables the work support system 1 to effectively support the work of users. For example, when the electronic document has been generated, when the notification destination defined in advance is notified, the user is not required to perform an operation for sending a notification to the notification destination by himself or herself, and hence the work support system 1 can reduce a work burden on the user.

### 6-11. Modification Example 11

For example, another user such as a superior or a colleague of the user may leave a comment on the electronic document generated by the work support system 1. Such a comment may be useful information when a new electronic document is generated the next time or later. In view of this, in Modification Example 11, a case in which a new electronic document is generated based on a comment of another user on the already-generated electronic document is taken as an example.

In Modification Example 11, the work support system 1 includes the second comment information acquisition module 215. The second comment information acquisition module 215 acquires the comment information relating to a comment on the already-generated electronic document generated by the generation-related processing executed in the past, the comment having been input by another user other than the user. The comment information is assumed to be stored in the work support database DB in association with the already-generated electronic document. The comment information in Modification Example 11 differs from the comment information in Modification Example 5 in that the comment has been left on the electronic document, but is similar to the comment information in Modification Example 5 in that the indicated comment has been registered in the work support system 1.

For example, the second comment information acquisition module 215 acquires the comment information from the work support database DB. The second comment information acquisition module 215 is only required to acquire the comment information from the work support database DB in the same manner as the first comment information acquisition module 208 acquires the comment information. The second comment information acquisition module 215 may acquire the comment information from another database other than the work support database DB, another computer other than the work support server 30, or an external information storage medium.

The generation-related processing execution module 203 in Modification Example 11 executes the generation-related processing further based on the comment information. The phrase “further based on the comment information” means that the subject is based on not only the registration data, the user input information, and the AI but also the comment information. For example, the generation-related processing execution module 203 inputs the input data including the comment information to the AI. The AI calculates the embedded representation based on not only the registration data and the user input information but also the comment information. The embedded representation reflects not only the registration data and the user input information but also the comment information. The AI outputs the output data including the electronic document corresponding to the calculated embedded representation. The generation-related processing execution module 203 acquires the electronic document included in the output data output by the AI. For example, the AI identifies what kind of electronic document is to be generated based on the embedded representation corresponding to the comment information, and generates an electronic document.

The generation-related processing in Modification Example 11 is not limited to the processing for generating an electronic document further based on the comment information. The generation-related processing in Modification Example 11 may be other processing as in the at least one embodiment. For example, the generation-related processing execution module 203 may execute the generation-related processing by generating data such as a CSV file further based on the comment information and importing the data into a default electronic document. The generation-related processing execution module 203 may execute the generation-related processing by generating an API request for requesting the generation of an electronic document further based on the comment information. The generation-related processing execution module 203 may execute the generation-related processing by generating code for the generation of an electronic document further based on the comment information.

The work support system 1 according to Modification Example 11 executes the generation-related processing further based on the comment information. This enables the work support system 1 to generate an electronic document specific to the comment information. For example, when another user has left a comment on the already-generated electronic document, the work support system 1 can generate an electronic document that conforms to the comment. When the other user who has left the comment is a superior, the work support system 1 can generate an electronic document that reflects content pointed out on the already-generated electronic document by the superior.

### 6-12. Other Modification Examples

For example, two or more of Modification Examples 1 to 11 may be combined.

For example, the functions described as being implemented by the voice conversion server 10 may be implemented by the generation-related server 20, the work support server 30, or the user terminal 40. The functions described as being implemented by the generation-related server 20 may be implemented by the voice conversion server 10, the work support server 30, or the user terminal 40. The functions described as being implemented by the work support server 30 may be implemented by the voice conversion server 10, the generation-related server 20, or the user terminal 40. The functions described as being implemented by the user terminal 40 may be implemented by the voice conversion server 10, the generation-related server 20, or the work support server 30. The respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, which is configured to support work of a user, the work support system comprising at least one processor configured to:
acquire registration data registered in the work support system;
acquire, based on input of the user, user input information relating to an electronic document to be generated;
execute generation-related processing relating to generation of the electronic document, based on the registration data, the user input information, and an AI; and
provide the electronic document to the user.

2. The work support system according to claim 1, wherein the at least one processor is configured to:
acquire setting information relating to a setting of the registration data; and
execute the generation-related processing further based on the setting information.

3. The work support system according to claim 1, wherein the at least one processor is configured to:
acquire a template document relating to the electronic document, the template document being provided in advance; and
execute the generation-related processing further based on the template document.

4. The work support system according to claim 1, wherein the at least one processor is configured to:
acquire selected registration data, which is a piece of the registration data selected by the user, and related registration data, which is another piece of the registration data relating to the piece of registration data, from among a plurality of pieces of the registration data; and
execute the generation-related processing based on the selected registration data and the related registration data.

5. The work support system according to claim 1, wherein the at least one processor is configured to:
acquire an already-generated electronic document generated by the generation-related processing executed in a past; and
execute the generation-related processing further based on the already-generated electronic document.

6. The work support system according to claim 1, wherein the at least one processor is configured to:
acquire comment information relating to a comment associated with the registration data; and
execute the generation-related processing further based on the comment information.

7. The work support system according to claim 1, wherein the at least one processor is configured to:
execute code generation processing for generating code relating to the generation of the electronic document as the generation-related processing; and
generate the electronic document based on the code generated by the code generation processing.

8. The work support system according to claim 1, wherein the at least one processor is configured to provide the electronic document to the user by executing processing for displaying, on a user terminal of the user, a screen that allows the user to correct the electronic document based on a deployment result of the electronic document.

9. The work support system according to claim 1, wherein the at least one processor is configured to:
acquire, based on input of the user, correction content information relating to correction content in the electronic document;
execute correction-related processing relating to generation of correction portion information relating to post-correction content of a correction portion corresponding to the correction content in the electronic document, based on the correction content information and the AI; and
correct the electronic document by replacing the correction portion in the electronic document by the correction portion information.

10. The work support system according to claim 1, wherein the at least one processor is configured to execute, when the electronic document has been generated, verification processing relating to verification of the electronic document.

11. The work support system according to claim 1, wherein the at least one processor is configured to execute, when the electronic document has been generated, work processing relating to the work in which the electronic document is used.

12. The work support system according to claim 1, wherein the at least one processor is configured to:
acquire comment information relating to a comment on an already-generated electronic document generated by the generation-related processing executed in a past, the comment having been input by another user other than the user; and
execute the generation-related processing further based on the comment information.

13. A work support method, comprising:
acquiring registration data registered in a work support system configured to support work of a user;
acquiring, based on input of the user, user input information relating to an electronic document to be generated;
executing generation-related processing relating to generation of the electronic document, based on the registration data, the user input information, and an AI; and
providing the electronic document to the user.

14. A non-transitory information storage medium having stored thereon a program for causing a computer to:
acquire registration data registered in a work support system configured to support work of a user;
acquire, based on input of the user, user input information relating to an electronic document to be generated;
execute generation-related processing relating to generation of the electronic document, based on the registration data, the user input information, and an AI; and
provide the electronic document to the user.
